(19) United States
(12) Patent Application Publication
(10) Pub. No.: US 2023/0292382 A1
(43) Pub. Date: Sep. 14, 2023

(54) INDICATING SOURCE AND DESTINATION DEVICES

(71) Applicant: Lenovo (Singapore) Pte. Ltd., New Tech Park (SG)

(72) Inventors: Joachim Loehr, Wiesbaden (DE); Prateek Basu Mallick, Dreieich (DE); Karthikeyan Ganesan, Kronberg im Taunus (DE); Ravi Kuchibhotla, Chicago, IL (US)

(21) Appl. No.: 18/019,435

(22) PCT Filed: Aug. 5, 2021
(86) PCT No.: PCT/IB2021/057176

§ 371 Date: Feb. 2, 2023

Related U.S. Application Data
(60) Provisional application No. 63/061,715, filed on Aug. 5, 2020.
(60) Provisional application No. 63/061,725, filed on Aug. 5, 2020.
(60) Provisional application No. 63/061,731, filed on Aug. 5, 2020.
(60) Provisional application No. 63/061,734, filed on Aug. 5, 2020.
(60) Provisional application No. 63/061,746, filed on Aug. 5, 2020.

(51) Int. Cl. H04W 76/14; H04L 69/22

(52) U.S. Cl. CPC H04W 76/14; H04L 69/22; H04W 88/04

(57) ABSTRACT

Apparatuses, methods, and systems are disclosed for indicating source and destination devices. One method includes generating, at a first user equipment, mapping information. The mapping information comprises mapping between a pair of a source identities, an index, and at least one destination identity. The method includes providing the mapping information to a second user equipment. The method includes generating a first data packet including sidelink data for a third user equipment. The method includes transmitting the first data packet from the first user equipment to the second user equipment. The second user equipment generates a second data packet at least based on the mapping information, the second data packet includes sidelink data for the third user equipment, and the second user equipment transmits the second data packet to the third user equipment.

### CROSS-REFERENCE TO RELATED APPLICATIONS

This application claims priority to U.S. Patent Application Ser. No. 63/061,715 entitled “APPARATUSES, METHODS, AND SYSTEMS FOR A SIDELINK RESOURCE ALLOCATION PROCEDURE FOR SIDELINK RELAY COMMUNICATION” and filed on Aug. 5, 2020 for Joachim Loehr, U.S. Patent Application Ser. No. 63/061,725 entitled “MECHANISMS FOR IMPROVED COMMUNICATIONS USING RELAY OVER SIDELINK RADIO INTERFACE” and filed on Aug. 5, 2020 for Prateek Basu Mallick, U.S. Patent Application Ser. No. 63/061,731 entitled “SELECTION OF RELAY DEVICE IN SIDELINK COMMUNICATIONS” and filed on Aug. 5, 2020 for Prateek Basu Mallick, U.S. Patent Application Ser. No. 63/061,734 entitled “MECHANISMS TO SUPPORT TRANSMISSION FEEDBACK OVER SIDELINK RELAY” and filed on Aug. 5, 2020 for Prateek Basu Mallick, and U.S. Patent Application Ser. No. 63/061,746 entitled “APPARATUSES, METHODS, AND SYSTEMS FOR DETERMINING THE BEHAVIOUR OF A SIDELINK RELAY UE USING MCR AND ZONE” and filed on Aug. 5, 2020 for Karthikeyan Ganesan, all of which are incorporated herein by reference in their entirety.

### FIELD

The subject matter disclosed herein relates generally to wireless communications and more particularly relates to indicating source and destination devices.

### BACKGROUND

In certain wireless communications networks, relays may be used to transmit and/or receive data transmitted between UEs. A relay device may need to know devices that transmit and/or receive data from the relay device.

### BRIEF SUMMARY

Methods for indicating source and destination devices are disclosed. Apparatuses and systems also perform the functions of the methods. One embodiment of a method includes generating, at a first user equipment, mapping information. The mapping information comprises mapping between a pair of a source identities, an index, and at least one destination identity. In some embodiments, the method includes providing the mapping information to a second user equipment. In certain embodiments, the method includes generating a first data packet including sidelink data for a third user equipment. In various embodiments, the method includes transmitting the first data packet from the first user equipment to the second user equipment. The second user equipment, in response to decoding the first data packet correctly, generates a second data packet at least based on the mapping information, the second data packet includes sidelink data for the third user equipment, and the second user equipment transmits the second data packet to the third user equipment.

One apparatus for indicating source and destination devices includes a first user equipment. In some embodiments, the apparatus includes a processor that: generates mapping information, wherein the mapping information includes mapping between a pair of a source identities, an index, and at least one destination identity; provides the mapping information to a second user equipment; and generates a first data packet including sidelink data for a third user equipment. In certain embodiments, the apparatus includes a transmitter that transmits the first data packet from the first user equipment to the second user equipment. The second user equipment, in response to decoding the first data packet correctly, generates a second data packet at least based on the mapping information, the second data packet includes sidelink data for the third user equipment, and the second user equipment transmits the second data packet to the third user equipment.

Another embodiment of a method for indicating source and destination devices includes generating, at a first user equipment, header information for a first data packet. The header information indicates a destination identifier corresponding to a third user equipment. In some embodiments, the method includes generating the first data packet including the header information and sidelink data for the third user equipment. In certain embodiments, the method includes transmitting the first data packet from the first user equipment to a second user equipment. The second user equipment, in response to decoding the first data packet correctly, generates a second data packet at least based on the header information, the second data packet includes sidelink data for the third user equipment, and the second user equipment transmits the second data packet to the third user equipment.

Another apparatus for indicating source and destination devices includes a first user equipment. In some embodiments, the apparatus includes a processor that: generates header information for a first data packet, wherein the header information indicates a destination identifier corresponding to a third user equipment; and generates the first data packet including the header information and sidelink data for the third user equipment. In various embodiments, the apparatus includes a transmitter that transmits the first data packet from the first user equipment to a second user equipment. The second user equipment, in response to decoding the first data packet correctly, generates a second data packet at least based on the header information, the second data packet includes sidelink data for the third user equipment, and the second user equipment transmits the second data packet to the third user equipment.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for indicating source and destination devices;

FIG. 2 is a schematic block diagram illustrating one embodiment of an apparatus that may be used for indicating source and destination devices;

FIG. 3 is a schematic block diagram illustrating one embodiment of an apparatus that may be used for indicating source and destination devices;

FIG. 4 is a schematic block diagram illustrating one embodiment of a system for relay communications;

FIG. 5 is a schematic block diagram illustrating one embodiment of a SL-SCH MAC PDU format;

FIG. 6 is a flow chart diagram illustrating one embodiment of a method for indicating source and destination devices; and

FIG. 7 is a flow chart diagram illustrating another embodiment of a method for indicating source and destination devices.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

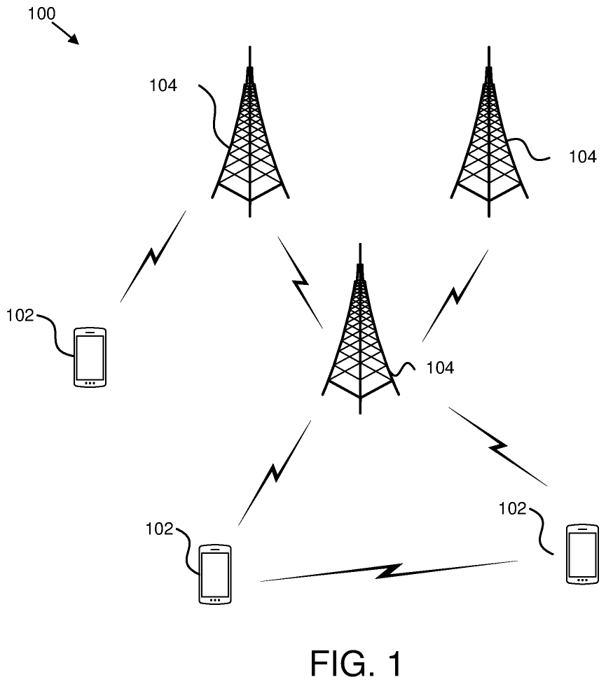

FIG. 1 depicts an embodiment of a wireless communication system 100 for indicating source and destination devices. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may generate, at a first user equipment, mapping information. The mapping information comprises mapping between a pair of a source identities, an index, and at least one destination identity. In some embodiments, the remote unit 102 may provide the mapping information to a second user equipment. In certain embodiments, the remote unit 102 may generate a first data packet including sidelink data for a third user equipment. In various embodiments, the remote unit 102 may transmit the first data packet from the first user equipment to the second user equipment. The second user equipment, in response to decoding the first data packet correctly, generates a second data packet at least based on the mapping information, the second data packet includes sidelink data for the third user equipment, and the second user equipment transmits the second data packet to the third user equipment. Accordingly, the remote unit 102 may be used for indicating source and destination devices.

In certain embodiments, a remote unit 102 may generate, at a first user equipment, header information for a first data packet. The header information indicates a destination identifier corresponding to a third user equipment. In some embodiments, the remote unit 102 may generate the first data packet including the header information and sidelink data for the third user equipment. In certain embodiments, the remote unit 102 may transmit the first data packet from the first user equipment to a second user equipment. The second user equipment, in response to decoding the first data packet correctly, generates a second data packet at least based on the header information, the second data packet includes sidelink data for the third user equipment, and the second user equipment transmits the second data packet to the third user equipment. Accordingly, the remote unit 102 may be used for indicating source and destination devices.

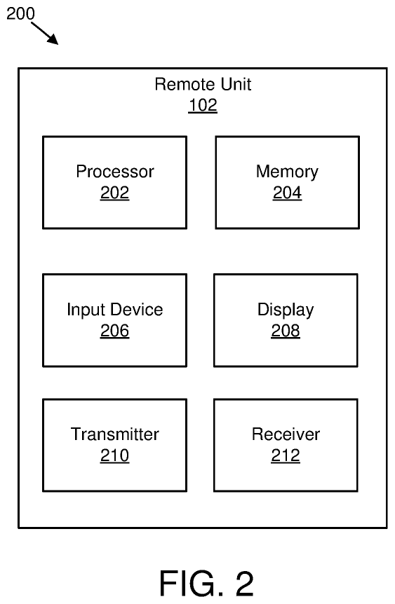

FIG. 2 depicts one embodiment of an apparatus 200 that may be used for indicating source and destination devices. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202: generates mapping information, wherein the mapping information includes mapping between a pair of a source identities, an index, and at least one destination identity; provides the mapping information to a second user equipment; and generates a first data packet including sidelink data for a third user equipment. In certain embodiments, the transmitter 210 transmits the first data packet from the first user equipment to the second user equipment. The second user equipment, in response to decoding the first data packet correctly, generates a second data packet at least based on the mapping information, the second data packet includes sidelink data for the third user equipment, and the second user equipment transmits the second data packet to the third user equipment.

In some embodiments, the processor 202: generates header information for a first data packet, wherein the header information indicates a destination identifier corresponding to a third user equipment; and generates the first data packet including the header information and sidelink data for the third user equipment. In various embodiments, the transmitter 210 transmits the first data packet from the first user equipment to a second user equipment. The second user equipment, in response to decoding the first data packet correctly, generates a second data packet at least based on the header information, the second data packet includes sidelink data for the third user equipment, and the second user equipment transmits the second data packet to the third user equipment.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

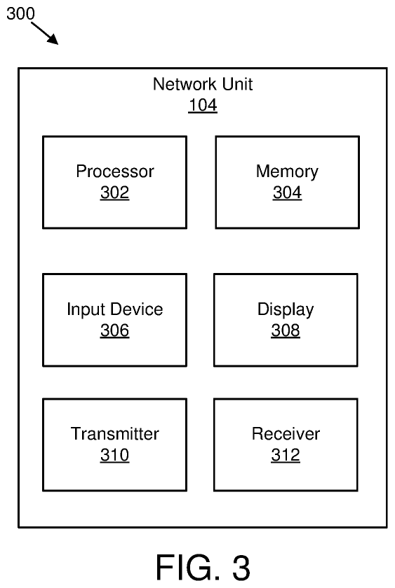

FIG. 3 depicts one embodiment of an apparatus 300 that may be used for indicating source and destination devices. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, there may be two types of relays: 1) UE-to-network coverage extension: UE to network (“Uu”) interface coverage reachability may be necessary for UEs to reach a server in a packet data network (“PDN”) or counterpart UE out of a proximity area—various embodiments for UE-to-network relays may be limited to evolved universal terrestrial access (“EUTRA”) based technologies, and may not be applied to an NR-based system (e.g., for both next generation (“NG”) radio access network (“RAN”) (“NG-RAN”) and NR-based sidelink communications); and 2) UE-to-UE coverage extension: current proximity reachability may be limited to a single-hop sidelink link either via EUTRA-based or NR-based sidelink technology—this may not be sufficient if there is no Uu coverage, considering a limited single-hop sidelink coverage.

In various embodiments, for both sidelink (“SL”) relay types, a SL remote UE may discover and select a relay for transmissions to another SL remote UE. SL data transmissions from a transmitter (“TX”) remote UE to a RX remote UE may travers an intermediate relay node (e.g., relay node that relays IP traffic between the TX remote and receiver (“RX”) remote UEs. The relay communicates with TX and RX remote UEs using sidelink communication over a PC5 interface. In certain embodiments, it may be unknown how sidelink resource allocation behavior is done at the TX remote UE for the transmission of sidelink data destined for different RX remote UEs served by the same relay Node. In some embodiments, there may be a sidelink resource allocation procedure at a relay UE considering latency incurred by the relaying data.

It should be noted that the following terminology is used in this document: 1) UE-to-network relay: N-relay; 2) UE-to-UE relay: UE-relay; and 3) Relay=either a UE-to-network relay or a UE-to-UE relay.

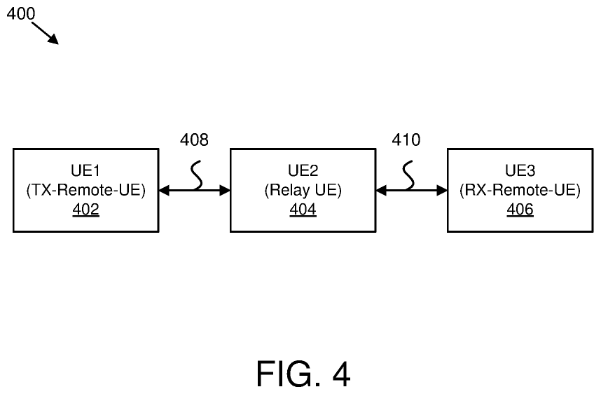

FIG. 4 is a schematic block diagram illustrating one embodiment of a system 400 for relay communications. The system 400 includes a UE1 402 (e.g., TX-Remote-UE, first UE, one or more transmit (“TX”) UEs), a UE2 404 (e.g., relay UE, second UE), and a UE3 406 (e.g., RX-Remote-UE, third UE, one or more RX UEs). The UE1 402 communicates with the UE2 404 over a first interface 408, while the UE2 404 communicates with the UE3 406 over a second interface 410.

The UE1 402 is a UE that has some application data to be sent to another remote UE (UE3 406) via a relay (UE2 404). It should be noted that, the UE3 406 may have data to send to the UE1 402 via the UE2 404 (in this context UE3 406 would take the role of a transmitter UE). Accordingly, the terms and roles shown in FIG. 4 may be with respect to a particular data packet. In some embodiments, more than one relay is used (e.g., UE2a and UE2b), thus the UE2 404 may be a generalized representation of one or more relay UEs. In various embodiments, UE3 406 may act as a relay UE to another UE (e.g., UE4).

In a first embodiment, a new indication may be used. The indication may indicate whether a transport block (“TB”) transmitted on a physical sidelink shared channel (“PSSCH”) is to be relayed by a relay node such as sidelink relay UE. Such an explicit indication may be transmitted as part of sidelink control information (“SCI”) on a physical sidelink control channel (“PSCCH”) associated with the PSSCH. In one implementation of the first embodiment, a one-bit flag is signaled within the SCI. The one-bit flag indicates whether the TB transmitted on the corresponding PSSCH should be relayed by a sidelink relay UE to a remote Rx UE. For scenarios where a transmitter (e.g., TX remote UE) is connected to a sidelink relay node that supports relaying traffic via a UE to UE (“PC5”) interface to other receiving UEs (e.g., RX remote UEs), such information may have various benefits. For example, a TX UE may transmit a PC5 message on PSSCH to a RX UE. Since the TX UE may be connected to a relay UE which is relaying traffic to the RX UE, the TX UE may control whether messages should be relayed or whether messages should be directly transmitted (e.g., without the interaction of a relay UE) to the receiving UE. It may not always be beneficial to relay messages to a receiving UE (e.g., if channel conditions between a TX and RX UE are sufficiently good).

In another implementation of the first embodiment, a sidelink (“SL”) shared channel (“SCH”) (“SL-SCH”) medium access control (“MAC”) protocol data unit (“PDU”) format may be used for the transmission of sidelink data that is relayed by a relay UE to an RX remote UE. The TX remote UE may signal within SCI a destination identifier (“ID”) of the RX remote UE. Furthermore, the SL-SCH MAC PDU may be generated according to a specified transport block generation procedure (e.g., logical channel prioritization procedure) with the destination field in the SL-SCH header set to the 8 most significant bits of the Destination Layer-2 ID of the RX remote UE. A relay UE may be able to receive and decode the SL-SCH MAC PDU that is being sent to the RX remote UE. For example, during the relay selection procedure where a connection between the TX remote UE and the relay UE is established, the relay UE may be provided with the Destination Layer-2 IDs of the Rx remote UEs for which the relay UE should relay sidelink data.

In a second embodiment, SCI corresponding to a PSSCH carrying sidelink data that is to be relayed by a relay UE to an RX remote UE indicates a destination ID of the relay UE (e.g., destination field within the SCI set to the destination ID of the relay UE). According to one implementation of the second embodiment, a destination field size in the SCI is 24 bits and is set to a Destination Layer-2 ID of the relay UE. The destination field in the corresponding SL-SCH subheader is set to the Destination Layer-2 ID of the RX remote UE. According to another implementation of the second embodiment, a destination field size within the SL-SCH subheader is 24 bits and is set to the Destination Layer-2 ID of the RX remote UE.

According to a further implementation of the second embodiment, a field in the SL-SCH subheader indicates a new version of the SL-SCH subheader including a destination field size of 24 bits.

In a third embodiment, a TX remote UE multiplexes sidelink data towards more than one RX remote UE served by the same relay node into a TB and sends the TB (e.g., SL MAC PDU) to the relay UE. In one implementation of the third embodiment, a new SL-SCH MAC PDU format is used in which a SL MAC PDU includes one or more SL-SCH subheaders. Each SL-SCH subheader is followed by one or more MAC subPDUs destined to the same destination. The content of the SL-SCH subheader may contain the following fields (e.g., the fields and related field description are one exemplary implementation to enable the multiplexing of data of different destinations into one TB): 1) V: the MAC PDU format version number field indicates which version of the SL-SCH subheader is used—the V field size is 4 bits—a new codepoint for the indication of the new SL-SCH MAC PDU format may be used; 2) source (“SRC”): the SRC field carries the 16 most significant bits of the Source Layer-2 ID field set to an identifier provided by upper layers; 3) destination (“DST”): it is set to the Destination Layer-2 ID of the RX remote UE provided by upper layers—the length of the field is 24 bits; 4) E: extension Flag: 1 bit indicating if there another SL-SCH subheader included in the SL-SCH MAC PDU; and/or 5) L: length field indicating a length of the MAC subPDUs followed a SL-SCH subheader.

TABLE 1

| | | | | |
|---|---|---|---|---|
| V | E | R | R | R |

SRC
DST
L
L

Table 1 is an example layout of one embodiment of a SL-SCH subheader.

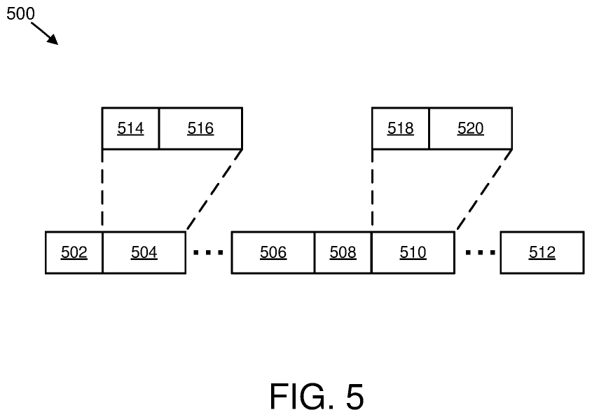

FIG. 5 is a schematic block diagram illustrating one embodiment of a SL-SCH MAC PDU format 500. The format 500 includes a first SL-SCH subheader 502 followed by one or more MAC subPDU including MAC service data unit (“SDU”) 504 and a MAC subPDU including MAC CE 506. The format 500 further includes a second SL-SCH subheader 508 followed by one or more MAC subPDU including MAC SDU 510 and a MAC subPDU including padding 512 (e.g., optional). The one or more MAC subPDU including MAC SDU 504 includes an R, F, logical channel identifier (“LCID”), and/or L subheader 514 and a MAC SDU 516. Moreover, the one or more MAC subPDU including MAC SDU 510 includes an R, F, LCID, and/or L subheader 518 and a MAC SDU 520.

In one implementation of the third embodiment, a MAC and/or logical channel prioritization (“LCP”) procedure considers only logical channels belonging to destinations that are served by the same relay node (e.g., in contrast to an LCP procedure in which a MAC considers only logical channels with the same Source Layer-2 ID-Destination Layer-2 ID pair for a LCP procedure and/or multiplexing of data into a TB). In such an implementation, a new logical channel restriction rule may be followed by a TX remote UE (e.g., MAC may consider only logical channels with a Source Layer-2 ID-Destination Layer-2 ID pair) where the Destination Layer-2 IDs are served by the same relay UE. In the third embodiment, in a first step, a first UE (e.g., TX remote UE) selects a destination having a logical channel with a highest priority or a MAC CE among the logical channels that satisfy certain conditions (e.g., SL data is available for transmission, SBj>0) and/or other defined logical channel (“LCH”) restrictions. In a second step, UE selects the logical channels which have a destination served by the same relay UE (e.g., if the destination selected in the first step is served by a relay UE). The subsequent steps of the LCP procedure/multiplexing and assembly procedure may be the same as for Rel-16.

In various implementations of the third embodiment, the SL-SCH subheader may contain a second destination field with a size of 8 its. The destination field may be set to the 8 most significant bits of the Destination Layer-2 ID of the relay UE provided by upper layers. The remaining 16 bits of the Destination Layer-2 ID of the relay UE may be carried within the corresponding SCI. Table 2 illustrates one embodiment of such implementations of the SL-SCH subheader.

TABLE 2

| | | | | |
|---|---|---|---|---|
| V | E | R | R | R |

SRC
DST (Rx remote UE)
DST (relay)
L
L

In a fourth embodiment, a mapping between a pair of a source Layer 2 ID, an index, and a Destination Layer-2 ID may be used, such that a receiver UE (e.g., relay UE) receiving a SL MAC PDU is capable of unambiguous identification based on the mapping information (e.g., the Destination Layer-2 ID of the RX remote UE to which MAC subPDUs of the SL MAC PDU shall be further relayed and/or transmitted). According to one implementation of the fourth embodiment, the index may be a logical channel ID or a SL radio bearer ID. In certain implementations of the fourth embodiment, the TX remote UE sets the destination ID of LCHs carrying data for RX remotes UEs served by the same relay UE during a logical channel prioritization procedure and for the construction of a sidelink MAC PDU to the same destination (e.g., Destination Layer-2 ID of the relay UE). In such an embodiment, a MAC considers, for a transport block generation procedure, all logical channels of RX remote UEs served by the same relay UE since they have the same Source Layer-2 ID-Destination Layer-2 ID pair. By setting the destination of the logical channels for a RX remote UE to the destination of the relay UE for a transport block generation procedure, it is possible to multiplex sidelink data towards more than one RX remote UE served by the same relay node into a MAC PDU using an LCP procedure. Furthermore, a SL-SCH subheader format may be reused for a SL data transmission to a relay UE. The destination field in the SL-SCH subheader is set to the 8 most significant bits of the Destination Layer-2 ID set of the relay node. In the accompanying SCI, the destination field is set to the 16 least significant bits of the relay Destination Layer-2 ID.

In certain configurations of the fourth embodiment, upon reception of a SL MAC PDU containing data transmitted towards multiple different Rx remote UEs, a relay UE sets a destination of individual LCHs having data in a MAC PDU back to an original Destination Layer-2 ID of a corresponding RX remote UE based on mapping information. According to one further implementation of the fourth embodiment, there may be an explicit indication (e.g., sent within SCI) indicating that the receiving UE (e.g., relay UE) may apply a mapping table for re-mapping of destination IDs of LCHs. Table 3 shows some examples of mapping table specifying a mapping between a pair of source Layer 2 IDs, an index (e.g., LCH ID) and a Destination Layer-2 ID.

TABLE 3

| Source layer 2 ID | Index | Destination Layer 2 ID |
|---|---|---|
| Source Layer 2 ID | LCH ID = 1 | Destination Layer 2 ID |
| (Remote Tx UE) | | (Remote Rx UE 1) |
| Source Layer 2 ID | LCH ID = 2 | Destination Layer 2 ID |
| (Remote Tx UE) | | (Remote Rx UE 1) |
| Source Layer 2 ID | LCH ID = 3 | Destination Layer 2 ID |
| (Remote Tx UE) | | (Remote Rx UE 2) |
| Source Layer 2 ID | LCH ID = 4 | Destination Layer 2 ID |
| (Remote Tx UE) | | (Remote Rx UE 2) |
| Source Layer 2 ID | LCH ID = 5 | Destination Layer 2 ID |
| (Remote Tx UE) | | (Remote Rx UE 3) |

In some embodiments, mapping information may be provided to a relay node as part of a relay selection procedure (e.g., if a relay UE provides relay service to a TX remote UE for sidelink traffic). The relay node may establish a one-to-one direct connection with the TX remote UE. The mapping information may be signaled by higher layer signaling (e.g., PC5 sidelink (“PC5-S”)) or provided to the relay node within a MAC control element. The mapping information may need to be updated whenever there is a change in a configuration of the services the relay UE provides to the TX remote UE (e.g., set of RX remote UEs served by the relay UE has changed).

According to one implementation of the fourth embodiment, mapping information may contain further information in addition to a mapping between a source Layer 2 ID, an index, and a Destination Layer-2 ID. For example, minimum communication range (“MCR”) information associated with a LCH may be provided by such mapping information to the relay UE (e.g., pair of a source Layer 2 ID and an index (e.g., LCH ID) maps not only to a Destination Layer-2 ID but also to an MCR value). Such MCR information may be used by the relay UE for the transmission of the sidelink data to the corresponding RX remote UEs. Table 4 shows one embodiment of mapping information that contains the source Layer 2 ID, the index, the Destination Layer-2 ID, and the MCR.

TABLE 4

| Source layer 2 ID | Index | Destination Layer 2 ID | MCR |
|---|---|---|---|
| Source Layer 2 ID | LCH | Destination Layer 2 ID | MCR value = x |
| (Remote Tx UE) | ID = 1 | (Remote Rx UE 1) | |
| Source Layer 2 ID | LCH | Destination Layer 2 ID | MCR value = y |
| (Remote Tx UE) | ID = 2 | (Remote Rx UE 1) | |
| Source Layer 2 ID | LCH | Destination Layer 2 ID | MCR value = z |
| (Remote Tx UE) | ID = 3 | (Remote Rx UE 2) | |
| Source Layer 2 ID | LCH | Destination Layer 2 ID | MCR value = x |
| (Remote Tx UE) | ID = 4 | (Remote Rx UE 2) | |
| Source Layer 2 ID | LCH | Destination Layer 2 ID | MCR value = x |
| (Remote Tx UE) | ID = 5 | (Remote Rx UE 3) | |

In a fifth embodiment, a new header information may be added to a packet and/or PDU of a SL LCH carrying a Destination Layer-2 ID of a destination a LCH belongs to. The header information may be used if data provided to multiple RX remote UEs is multiplexed in the same TB in which the TB is sent to the relay UE. The header information may be added at the TX remote UE for LCHs belonging to Rx remote UEs that are served by a relay UE that is used by a receiver UE (e.g., relay UE) to unambiguously identify a Destination Layer-2 ID of the RX remote UE to which a packet and/or PDU of a SL LCH may be further relayed and/or transmitted. According to one implementation of the fifth embodiment, the new header information may be part of a packet data convergence protocol (“PDCP”) header (e.g., new field added to the PDCP header). According to another implementation of the fifth embodiment, a new field may be part of a header of a new protocol layer (e.g., sitting above a PDCP layer to enabling ciphering of Destination Layer-2 ID information carried in the field). The new header may include a destination field added to an incoming packet (e.g., from an internet protocol (“IP”) layer) and may be submitted to the PDCP layer at a transmitter side (e.g., TX remote UE). On the receiver side (e.g., relay UE), the header may be removed.

In various embodiments, similar to a behavior outlined in the fourth embodiment, a TX remote UE sets a destination ID of LCHs carrying data for RX remote UEs served by the same relay UE if generating a sidelink MAC PDU in a SL-SCH subheader to a Destination Layer-2 ID of the relay UE. In such embodiments, a MAC considers, for a transport block generation procedure, all logical channels of RX remote UEs that are served by the same relay node, since they have the same Source Layer-2 ID-Destination Layer-2 ID pair. Accordingly, multiplexing of sidelink data towards more than one RX remote UE served by the same relay node into a MAC PDU may be done. In SCI, a destination field may be set to 16 least significant bits of the relay Destination Layer-2 ID.

In certain embodiments, upon reception of a SL MAC PDU containing data intended for multiple RX remote UEs, a relay UE uses new header information to identify an original Destination Layer-2 ID that a LCH belongs to. Accordingly, the relay UE uses the Destination Layer-2 ID carried in the header information for the transmission of corresponding data to the individual RX remote UEs.

In some embodiments, one problem with relaying data may be an increased latency due to additional hops in a transmission path that may adversely impact performance of both user and control plane data transmission. Such increased latency may be more pronounced in a multi-hop scenario, where a data packet traverses multiple relay UEs before reaching the RX remote UE. In such embodiments, it may be important to reduce an end to end (“E2E”) delay from the TX remote UE to the RX remote UE and meet latency requirements.

In various embodiments, if a relay node is integrated in a transmission between a TX remote UE and an RX remote UE, data arriving from a TX remote UE may suffer scheduling delays at the relay node (and further intermediate relay nodes). In a multi-hop network, delays are likely to accumulate due to the number of hops and related multiple consecutive resource request and allocation steps. In such embodiments, an underlying reason for these delays may be that a relay UE may only request or start a resource allocation procedure for sidelink resources after it actually receives the data from the TX remote UE which is to be further relayed to the RX remote UEs or next relay UE.

In a sixth embodiment, to avoid or reduce delays, a sidelink resource request procedure or a sidelink resource allocation procedure may be started and/or triggered at a relay node based on SL data that is expected to arrive or based on information about the arrival of SL data from a TX remote UE. For example, a relay UE may already request sidelink resources from a gNB (e.g., assuming resource allocation mode 1) or trigger a SL resource selection procedure (e.g., for resource allocation mode 2) based on received buffer status information and/or data assistance information from a TX remote UE. This may enable the relay node to obtain sidelink resources prior to actual data reception from the TX remote UE. This may trigger sidelink resource selection or requesting sidelink resources from the gNB by sending a scheduling resource (“SR”) and/or BSR based on the reception of data assistance information from the TX remote UE and before the reception of the actual SL data (e.g., referred to as “early SL resource selection”).

According to one implementation of the sixth embodiment, data assistance information may include an amount of data (e.g., in bytes) per destination (e.g., destination layer 2 ID of the RX remote UE) that is in a TX remote UE's buffer. In other words, the data assistance information may provide a snapshot of the data for the RX remote UEs served by the relay UE residing in the TX remote UE's buffer. Such information may be provided to the relay UE by means of a MAC CE. The transmission of the MAC CE from the TX remote UE to the relay UE may be triggered based on one of the following events: 1) expiry of a timer; 2) amount of data in the TX remote UE's buffer for RX remote UEs served by the same relay exceeding a predefined threshold; and/or 3) data of latency critical LCHs arriving in the TX remote UE's buffer.

According to another implementation of the sixth embodiment, a TX remote UE provides a generated sidelink BSR that is transmitted to the gNB on a UE to network (“Uu”) interface (e.g., for resource allocation mode 1) and also to the relay UE.

According to a further implementation of the sixth embodiment, the data assistance information may include information about a periodicity and/or TB size of data being relayed by the relay node to an RX remote UE. In particular, for periodic traffic it may be beneficial to provide the relay node with traffic characteristics (e.g., periodicity, TB size, etc.) in advance to enable the relay node to consider such information for an optimized sidelink resource allocation on the second interface provided to the RX remote UEs.

In various embodiments, upon reception of data assistance information, a relay node may trigger a SL resource selection procedure (e.g., SL resource selection procedure is triggered based on data that is expected to be received in contrast to the being triggered based on data which is actually available at the relay node for transmission). Similarly, the relay node may trigger a scheduling request and/or BSR (e.g., for resource allocation mode 1) based on data that is expected to be received. A sidelink buffer status report sent to a gNB may indicate sidelink data that is expected to be received in contrast to a buffer status report indicating data which is actually available (e.g., at a MAC entity) for transmission. In such embodiments, a sidelink buffer status report may be conveyed in a MAC CE that has a different format than other sidelink BSR MAC CE (e.g., long, short, and/or truncated BSR MAC CE). In certain embodiments, a MAC CE format for the new type of sidelink BSR enables reporting a buffer status with a different granularity than other BSRs. Furthermore, such embodiments may enable a gNB to distinguish between certain BSR information and a new type of BSR information indicating an amount of data that is expected be received. Such distinguishing may be beneficial to facilitate reducing a risk that the gNB allocates sidelink resources based on a received BSR before the actual data has been received at a relay node.

In some embodiments, a TX remote UE may request sidelink resources from a gNB for a transmission to a relay node (e.g., via the first interface 408), and for a transmission from the relay UE to an RX remote UE (e.g., via the second 410 interface). In such embodiments, both the TX remote UE and the relay UE are connected to the same gNB.

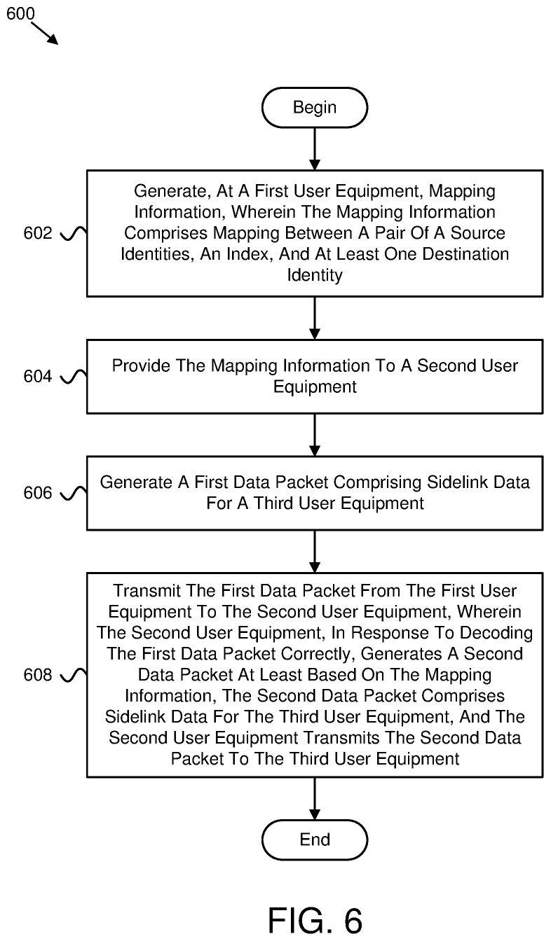

FIG. 6 is a flow chart diagram illustrating one embodiment of a method 600 for indicating source and destination devices. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes generating 602, at a first user equipment, mapping information. The mapping information comprises mapping between a pair of a source identities, an index, and at least one destination identity. In some embodiments, the method 600 includes providing 604 the mapping information to a second user equipment. In certain embodiments, the method 600 includes generating 606 a first data packet including sidelink data for a third user equipment. In various embodiments, the method 600 includes transmitting 608 the first data packet from the first user equipment to the second user equipment. The second user equipment, in response to decoding the first data packet correctly, generates a second data packet at least based on the mapping information, the second data packet includes sidelink data for the third user equipment, and the second user equipment transmits the second data packet to the third user equipment.

In certain embodiments, the index is a logical channel identity or a sidelink radio bearer identity. In some embodiments, the second user equipment is a relay node. In various embodiments, the source identity is a source layer 2 identifier of the first user equipment.

In one embodiment, the destination identity is a destination layer 2 identifier of the third user equipment. In certain embodiments, providing the mapping information to the second user equipment comprises transmitting the mapping information via higher layer signaling or within a medium access control control element.

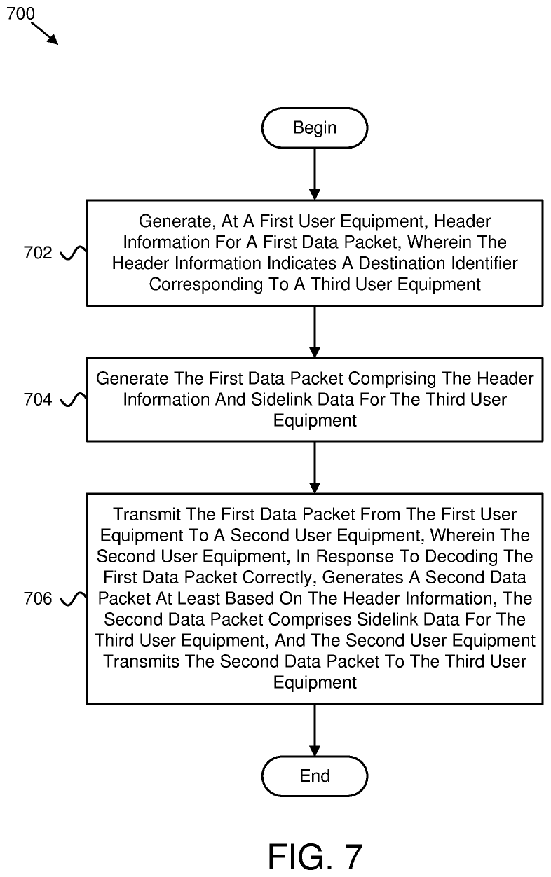

FIG. 7 is a flow chart diagram illustrating another embodiment of a method 700 for indicating source and destination devices. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes generating 702, at a first user equipment, header information for a first data packet. The header information indicates a destination identifier corresponding to a third user equipment. In some embodiments, the method 700 includes generating 704 the first data packet including the header information and sidelink data for the third user equipment. In certain embodiments, the method 700 includes transmitting 706 the first data packet from the first user equipment to a second user equipment. The second user equipment, in response to decoding the first data packet correctly, generates a second data packet at least based on the header information, the second data packet includes sidelink data for the third user equipment, and the second user equipment transmits the second data packet to the third user equipment.

In certain embodiments, the second user equipment is a relay node. In some embodiments, the destination identifier comprises a destination layer 2 identifier of the third user equipment. In various embodiments, the header information comprises a packet data convergence protocol header.

In one embodiment, a method comprises: generating, at a first user equipment, mapping information, wherein the mapping information comprises mapping between a pair of a source identities, an index, and at least one destination identity; providing the mapping information to a second user equipment; generating a first data packet comprising sidelink data for a third user equipment; and transmitting the first data packet from the first user equipment to the second user equipment, wherein the second user equipment, in response to decoding the first data packet correctly, generates a second data packet at least based on the mapping information, the second data packet comprises sidelink data for the third user equipment, and the second user equipment transmits the second data packet to the third user equipment.

In certain embodiments, the index is a logical channel identity or a sidelink radio bearer identity.

In some embodiments, the second user equipment is a relay node.

In various embodiments, the source identity is a source layer 2 identifier of the first user equipment.

In one embodiment, the destination identity is a destination layer 2 identifier of the third user equipment.

In certain embodiments, providing the mapping information to the second user equipment comprises transmitting the mapping information via higher layer signaling or within a medium access control control element.

In one embodiment, an apparatus comprises a first user equipment. The apparatus further comprises: a processor that: generates mapping information, wherein the mapping information comprises mapping between a pair of a source identities, an index, and at least one destination identity; provides the mapping information to a second user equipment; and generates a first data packet comprising sidelink data for a third user equipment; and a transmitter that transmits the first data packet from the first user equipment to the second user equipment, wherein the second user equipment, in response to decoding the first data packet correctly, generates a second data packet at least based on the mapping information, the second data packet comprises sidelink data for the third user equipment, and the second user equipment transmits the second data packet to the third user equipment.

In certain embodiments, the index is a logical channel identity or a sidelink radio bearer identity.

In some embodiments, the second user equipment is a relay node.

In various embodiments, the source identity is a source layer 2 identifier of the first user equipment.

In one embodiment, the destination identity is a destination layer 2 identifier of the third user equipment.

In certain embodiments, the processor providing the mapping information to the second user equipment comprises the transmitter transmitting the mapping information via higher layer signaling or within a medium access control control element.

In one embodiment, a method comprises: generating, at a first user equipment, header information for a first data packet, wherein the header information indicates a destination identifier corresponding to a third user equipment; generating the first data packet comprising the header information and sidelink data for the third user equipment; and transmitting the first data packet from the first user equipment to a second user equipment, wherein the second user equipment, in response to decoding the first data packet correctly, generates a second data packet at least based on the header information, the second data packet comprises sidelink data for the third user equipment, and the second user equipment transmits the second data packet to the third user equipment.

In certain embodiments, the second user equipment is a relay node.

In some embodiments, the destination identifier comprises a destination layer 2 identifier of the third user equipment.

In various embodiments, the header information comprises a packet data convergence protocol header.

In one embodiment, an apparatus comprises a first user equipment. The apparatus further comprises: a processor that: generates header information for a first data packet, wherein the header information indicates a destination identifier corresponding to a third user equipment; and generates the first data packet comprising the header information and sidelink data for the third user equipment; and a transmitter that transmits the first data packet from the first user equipment to a second user equipment, wherein the second user equipment, in response to decoding the first data packet correctly, generates a second data packet at least based on the header information, the second data packet comprises sidelink data for the third user equipment, and the second user equipment transmits the second data packet to the third user equipment.

In certain embodiments, the second user equipment is a relay node.

In some embodiments, the destination identifier comprises a destination layer 2 identifier of the third user equipment.

In various embodiments, the header information comprises a packet data convergence protocol header.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
generating, at a first user equipment, mapping information, wherein the mapping information comprises mapping between a pair of a source identities, an index, and at least one destination identity;
providing the mapping information to a second user equipment;
generating a first data packet comprising sidelink data for a third user equipment; and
transmitting the first data packet from the first user equipment to the second user equipment, wherein the second user equipment, in response to decoding the first data packet correctly, generates a second data packet at least based on the mapping information, the second data packet comprises sidelink data for the third user equipment, and the second user equipment transmits the second data packet to the third user equipment.

2. The method of claim 1, wherein the index is a logical channel identity or a sidelink radio bearer identity.

3. The method of claim 1, wherein the second user equipment is a relay node.

4. The method of claim 1, wherein the destination identity is a destination layer 2 identifier of the third user equipment.

5. An apparatus comprising a first user equipment, the apparatus further comprising:
a processor that:
generates mapping information, wherein the mapping information comprises mapping between a pair of a source identities, an index, and at least one destination identity;
provides the mapping information to a second user equipment; and
generates a first data packet comprising sidelink data for a third user equipment; and
a transmitter that transmits the first data packet from the first user equipment to the second user equipment, wherein the second user equipment, in response to decoding the first data packet correctly, generates a second data packet at least based on the mapping information, the second data packet comprises sidelink data for the third user equipment, and the second user equipment transmits the second data packet to the third user equipment.

6. The apparatus of claim 5, wherein the index is a logical channel identity or a sidelink radio bearer identity.

7. The apparatus of claim 5, wherein the source identity is a source layer 2 identifier of the first user equipment.

8. The apparatus of claim 5, wherein the destination identity is a destination layer 2 identifier of the third user equipment.

9. The apparatus of claim 5, wherein the processor providing the mapping information to the second user equipment comprises the transmitter transmitting the mapping information via higher layer signaling or within a medium access control control element.

10. (canceled)

11. (canceled)

12. An apparatus comprising a first user equipment, the apparatus further comprising:
a processor that:
generates header information for a first data packet, wherein the header information indicates a destination identifier corresponding to a third user equipment; and
generates the first data packet comprising the header information and sidelink data for the third user equipment; and
a transmitter that transmits the first data packet from the first user equipment to a second user equipment, wherein the second user equipment, in response to decoding the first data packet correctly, generates a second data packet at least based on the header information, the second data packet comprises sidelink data for the third user equipment, and the second user equipment transmits the second data packet to the third user equipment.

13. The apparatus of claim 12, wherein the second user equipment is a relay node.

14. The apparatus of claim 12, wherein the destination identifier comprises a destination layer 2 identifier of the third user equipment.

15. The apparatus of claim 12, wherein the header information comprises a packet data convergence protocol header.

16. The method of claim 1, wherein the source identity is a source layer 2 identifier of the first user equipment.

17. The method of claim 1, wherein providing the mapping information to the second user equipment comprises transmitting the mapping information via higher layer signaling or within a medium access control control element.

18. The apparatus of claim 5, wherein the second user equipment is a relay node.
